(19) United States
(12) Patent Application Publication
(10) Pub. No.: US 2010/0278554 A1
(43) Pub. Date: Nov. 4, 2010

(54) Laser Printer Toner Cartridge Cleaning Blade

(76) Inventors: Jesus Gonzalez Perez, Chatsworth, CA (US); Stott Lenahan, Castaic, CA (US)

Correspondence Address: Micro Solutions Enterprises, 8201 Woodley Ave, Van Nuys, CA, 91406, US

(21) Appl. No.: 12/695,762

(22) Filed: Jan. 28, 2010

Related U.S. Application Data
(63) Continuation of application No. 12/433,562, filed on Apr. 30, 2009, now abandoned.

(51) Int. Cl. G03G 15/00; G03G 15/08

(52) U.S. Cl. 399/109; 399/262

(57) ABSTRACT

Process and apparatus for reducing and/or eliminating chances of new or used cleaning blades, installed in a laser printer toner cartridge, failing in operation due to high friction forces applied by the photo-sensitive member, achieved by trimming the corners of the polymeric section of the blade so that the corners are not at 90-degree angles, and thus reducing the forces and pressure applied on the corners, or by fabricating new cleaning blades with angled or rounded corners that do not have 90-degree angles.

### FIELD OF INVENTION

The invention relates generally to the field of original laser printer toner cartridges and remanufactured laser toner cartridges.

### BACKGROUND OF INVENTION

Laser printer technology including the associated toner cartridges is a fast growing, highly competitive industry that strives for continuous improvements related to the performance of cartridges and printers. Some examples of print characteristics that manufacturers are continuously trying to improve include print quality, print resolution, print speed, cost, and versatility of equipment, such as to enable printing, copying and photographing.

The present cleaning blade designs relate to the print speed characteristic, and are directed to laser toner printer and cartridge manufacturers' goal of constantly trying to increase the print speed. There are numerous parameters that limit the increase of print speed. Examples of those parameters include toner powder ability to flow, toner powder melting point, toner powder chargeability, cleaning blade performance and durability.

The conventional cartridge cleaning blade, also known as the wiper blade, is made of a metal bracket and a polymer strip. The function of the cleaning blade is to remove toner residue from the photosensitive member after a toner image has been transferred onto the paper, and, in order to prepare the photosensitive member for creation of another image. The process of cleaning the photosensitive member with the cleaning blade is usually done by the polymer strip, which is usually made of polyurethane and lies against the surface of the photosensitive member. During operation the polyurethane strip wipes the toner residue, like a squeegee, into the toner waste bin. The polymeric strip is typically connected to a metal bracket that is, in most cases, screwed to the waste bin. Continuous pressure is applied by the polymer strip of the cleaning blade to the photosensitive member in order to assure effective cleaning. Failure to effectively clean the surface of the photosensitive member results in print defects called “back grounding” and/or “double image”. In those types of defects the image shown on a prior page appears faintly on the next page printed. Generally, higher or greater force of the blade on the surface of the photosensitive member results in better cleaning. However, the force applied on the photosensitive member, also known as the drum, by the polymeric strip of the cleaning blade can cause negative effects. For example, the force applied by the cleaning blade can wear the sensitive coating on the drum as well as on the polymeric layer of the blade sufficient to create light print quality.

Also, excessive force can cause the polymeric section or strip of the blade to turn to the other side of the drum, thus causing complete failure of the toner cartridge, as explained with particular reference to FIG. 5. This phenomenon is known as “flipping blade”. Higher print speed results in higher friction force between the drum and the cleaning blade, and that in turn results in greater probability of flipping the cleaning blade. It is presently believed that the main parameters affecting the susceptibility of the cleaning blade to flipping are: (1) printing speed; (2) shape of the cleaning blade; (3) the polymeric material the cleaning blade is made of; (4) orientation of the cleaning blade with relation to the drum; (5) the type of drum coating; and, (6) the pressure that the cleaning blade applies to the drum.

A known method for preventing cleaning blades from flipping is lubricating the polymer strip. This method is effective in many applications, especially in original laser toner cartridges, because all components of the cartridge are designed by the manufacturer to prevent flipping. In the remanufacturing industry, replacement components are often used on the original design cartridge housing, and often times, the combination of different components, including the developing toner, can cause the cleaning blade to flip. Moreover, original equipment component cleaning blades, when used a second or third time or cycle in remanufacturing a cartridge, have a higher tendency to flip. It is believed that this tendency is due to degradation of the mechanical and physical properties of the cleaning blade. Moreover, it is believed that original cleaning blades have not been designed to perform with replacement toners or drums, and thus can be more susceptible flipping when subjected to a remanufacturing environment in which different tolerances in dimensions and different physical properties of materials are found.

Embodiments of a modified wiper blade and a modification process to alter the shape of the cleaning blade's polymeric section are described below. These embodiments function to significantly reduce, and in most cases eliminate the flipping cleaning blade phenomenon described above.

### SUMMARY OF THE INVENTION

In accordance with the embodiments described herein the drawbacks and problems associated with flipping cleaning blades in high speed printing (over 20 pages per minute) and wide format printers are overcome. High forces applied to the cleaning blade parallel to the direction of rotation of the drum are believed to cause the polymeric section of the cleaning blade to turn under the drum and thus cause the cartridge to fail. It is believed that by creating the shape of the polymeric section of the cleaning blade in a new cleaning blade, or by modifying the shape of the polymeric section of an existing cleaning blade, during operation of the printer relatively less torque is applied to the corners of the polymeric section, thus significantly reducing or eliminating the chances of the drum “grabbing” the blade and turning it under itself. Moreover, it is believed that the modification to the distal edges of the polymeric strip increases the stiffness of the edges of the polymeric section of the cleaning blade, so that such a modified cleaning blade has more stiffness than a cleaning blade with 90-degree corners at the leading edges of its polymeric strip, thus reducing the chances of blade flip.

These and other embodiments, features, aspects and advantages of the invention will become better understood with regard to the following description, appended claims and accompanying drawings.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 is a perspective view of a prior art cleaning blade without modification;

FIG. 2 is a perspective view of the FIG. 1 cleaning blade including two preferred modifications;

FIG. 3 is a perspective view of the FIG. 1 embodiment illustrating the orientation of the cleaning blade and the photosensitive member as assembled on the laser toner cartridge's waste bin;

FIG. 4 is a perspective view of the FIG. 1 embodiment illustrating the “flipping blade” phenomenon;

FIG. 5 is a perspective view of a preferred embodiment of a modified cleaning blade of the type shown in FIG. 1;

FIG. 6a is a cross-sectional view of the FIG. 1 cleaning blade before or prior to flipping;

FIG. 6b is a cross-sectional view of the FIG. 1 cleaning blade after the polymeric strip of the blade has been flipped;

FIG. 7 is a perspective view of a preferred tool for use in modifying a conventional cleaning blade of the type shown in FIG. 1;

FIG. 8a is a top view illustrating preferred cleaning blade modifications; and,

FIG. 8b is a top view illustrating alternate cleaning blade modifications.

Reference symbols or names are used in the Figures to indicate certain components, aspects or features shown therein. Reference symbols common to more than one Figure indicate like components, aspects or features shown therein.

### DETAILED DESCRIPTION

With reference to the Figures preferred embodiments of the present designs and processes will be described. These designs and methods address the cleaning blade flipping phenomenon phenomena that has been a source of problems in the laser printer industry. In its preferred embodiments the right and left leading edge corners of the cleaning blade polymeric strip are trimmed into a new, predetermined shape, which shape can take different forms. The shape or trimmed edge design can also be applied to new blades, thus fabricating a brand new blade with a more robust design that is resistant to flipping.

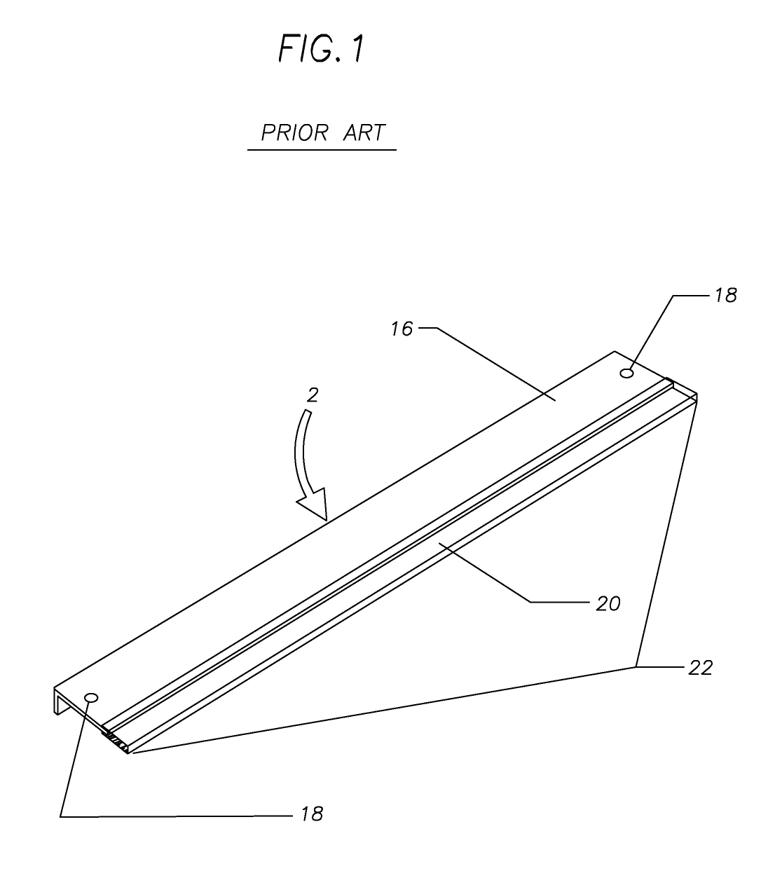

FIG. 1 shows a prior art, commonly used cleaning blade typically found in a conventional laser toner cartridge. Metal bracket (16) is typically fastened to the cartridge waste bin (not illustrated) by two screws that pass through two holes (18, 18). Flexible, polymeric section or strip (20) of the blade is commonly attached to the metal bracket (16) by molding the polymeric strip onto the bracket (22). The cleaning blade extends along the axis of rotation of the image carrier drum of the cartridge. The polymeric strip typically is a rectangular solid having a top surface, a bottom surface, a first side edge, a second side edge, a front edge having a width that extends across the printing surface and a back edge. The front edge is the leading edge and is the edge that contacts the drum during operation of the printer. The back edge is also known as the trailing edge. The side edges, also referred to as the distal edges, extend backwards, away from the leading edge and away from the drum. Front corners are formed where the front edge meets or joins with the side edges and rear or back corners are formed where the back edge joins or meets the side edges.

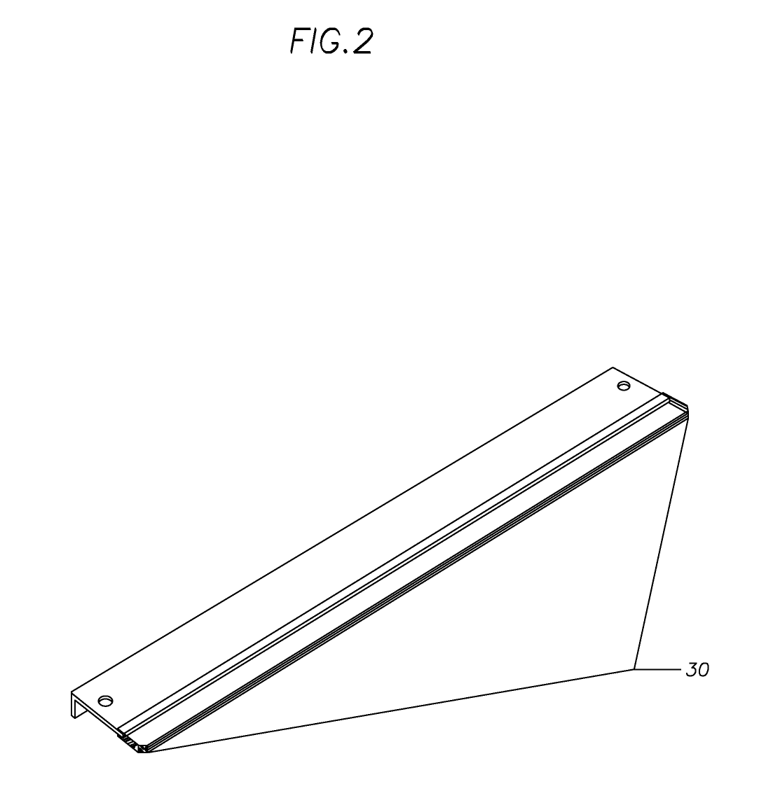

FIG. 2 illustrates a preferred embodiment of the present modified cleaning blade. In one form of the modified blade, a commonly used cleaning blade is modified after at least one cycle of use. Shown in FIG. 2 is a modified blade, that is, after the distal ends of the leading edge of the polymeric section or strip have been trimmed in accordance with the present process. The trimmed corners are shown at (30). While the trimmed edges at 30 are preferably provided on a previously used blade, the distal end corners of a new blade may also be trimmed as shown in FIG. 2.

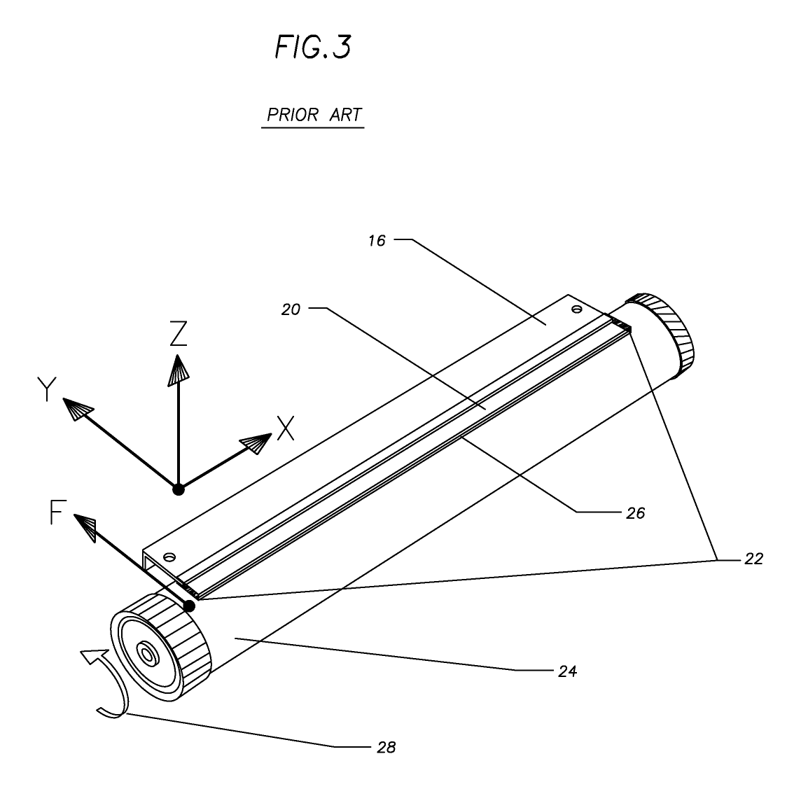

Again referring to FIG. 2, as well as FIG. 3, it may be seen that the cleaning blade is formed of a metal bracket and a polymeric strip. The strip is fastened to the bracket. For reference purposes the blade typically is of an “L” shape, with the strip fastened along one edge of the longer leg of the “L”. The longer leg of the “L” and the strip each has a width, a length and a thickness. With reference to FIG. 3, the width of each is the dimension that extends along the axis of the roller. The length of each of the longer leg of the “L” bracket and of the strip extends in the Y direction as shown in FIG. 3. Thus, the width of the bracket and the width of the strip extend in the X direction as shown in FIG. 3, and would correspond to the width of a sheet of paper that is fed through the printer. The thickness of the longer leg of the “L” bracket and the thickness of the strip extend in the Z direction. As is apparent from FIG. 3, the width of the strip is greater than its length.

The polymer strip can be initially molded in the shape shown in FIG. 2, or alternatively in another shape whereby the edges are trimmed from a straight, right-angled shape to some difference angle or to have rounded edges. FIG. 2 shows one example, of several shapes into which the distal edges of the blade's polymeric strip can be trimmed or to molded.

FIG. 3 is a drawing that illustrates the orientation of the prior art cleaning blade and the photosensitive member once assembled in the laser toner cartridge's waste bin. The polymeric section (20) presses against the drum surface (24). The drum (24) rotates in the direction of arrow (28). As drum (24) rotates, a force (F) is applied in the direction of the Y axis to the distal edge corners of the polymer strip (22) and to the leading edge of the polymer strip (26) as it touches the rotating drum (24).

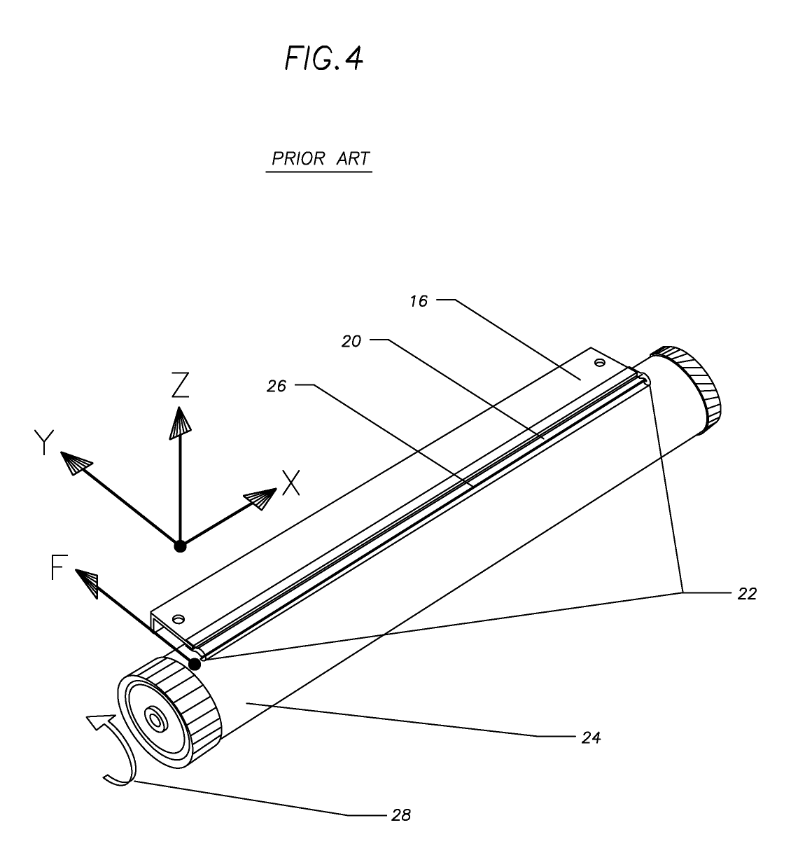

FIG. 4 illustrates the prior art phenomenon of flipping blade. As the drum (24) rotates in the direction of the arrow (28) it can, and often does grab one or both of the distal edges or corners of the polymer strip, shown at (22). The force (F) then bends the polymeric strip underneath itself. It is believed that the distal edges and corners (22) are more flexible than the polymer strip's leading edge (26), and thus these corner distal edges bend first. Once one of the corners bends over, it then pulls the rest of the leading edge, shown along line (26), with it. Moreover, it is believed that the force (F) applied on the corner (s) (22) along the y-axis creates a high local pressure, that initiates the flip.

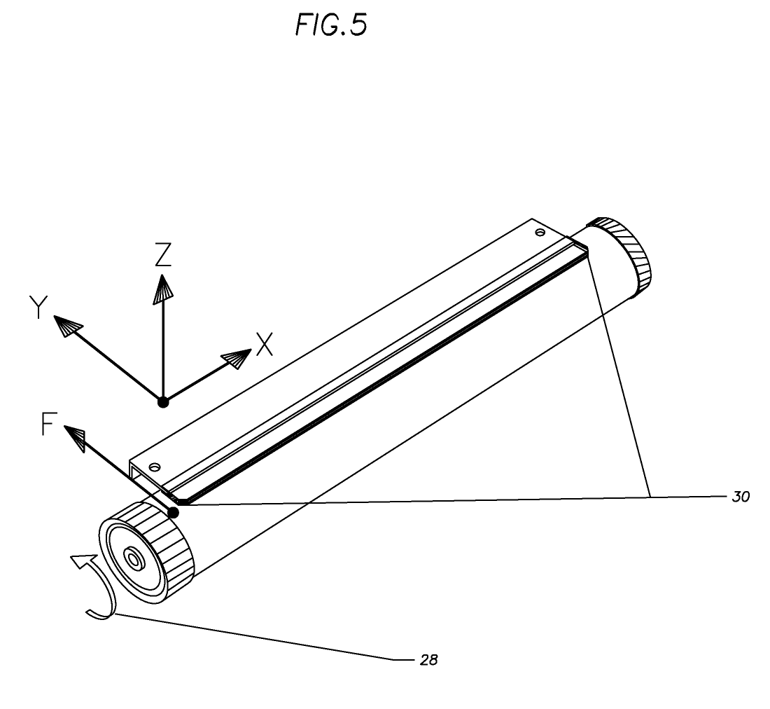

FIG. 5 illustrates the orientation of the cleaning blade and the drum assembled in the cartridge's waste bin (not illustrated) after the corners or distal or side edges of the polymeric strip have been modified, as shown at (30). It is believed that the force (F) along the y-axis is then spread along the chamfer, or other shape (30) at these corners or distal edges, so that the pressure applied on the polymer strip is reduced in comparison to the applied pressure on the unmodified cleaning blade. In general, it is believed that chamfering or rounding the edge makes the area more rigid, thus reducing the chances of flipping.

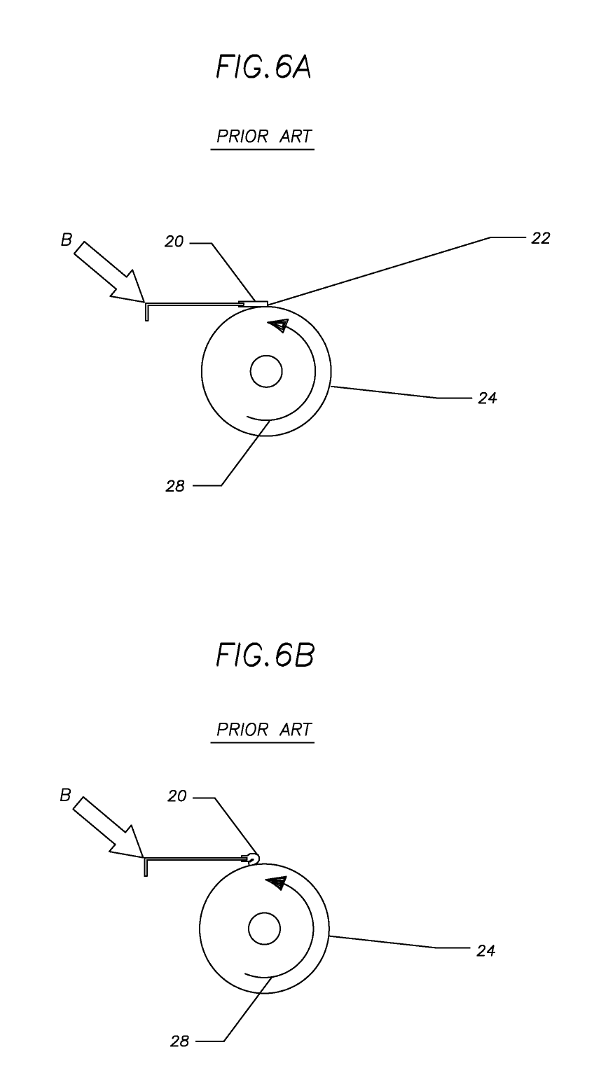

FIGS. 6A and 6B are cross-sectional views of the blade flipping phenomenon. FIG. 6a is a cross sectional view illustrating the flip phenomenon and shows the orientation of the cleaning blade (B), the polymeric section or strip (20), the drum (24) rotating in the direction of arrow (28) and edge (22). The leading edge of the polymeric strip is the edge that first contacts the drum as it rotates in the direction of arrow 28 shown in FIG. 6A, and extends along the X axis for the entire width of the strip. This leading edge is vertically oriented along the Z axis, and is the edge shown at (22) in FIG. 6A. Thus, in their preferred forms, the trimmed edges are at the distal ends of the polymeric strip and at the leading edge of the strip, as opposed to the trailing edge of the polymeric strip. FIG. 6B is a cross sectional view that illustrates the flipped blade where the drum (24) has been turned in the direction of the arrow (28) and grabbed the edge (22) of the polymer section or strip (20) and pulled the strip 20 under itself.

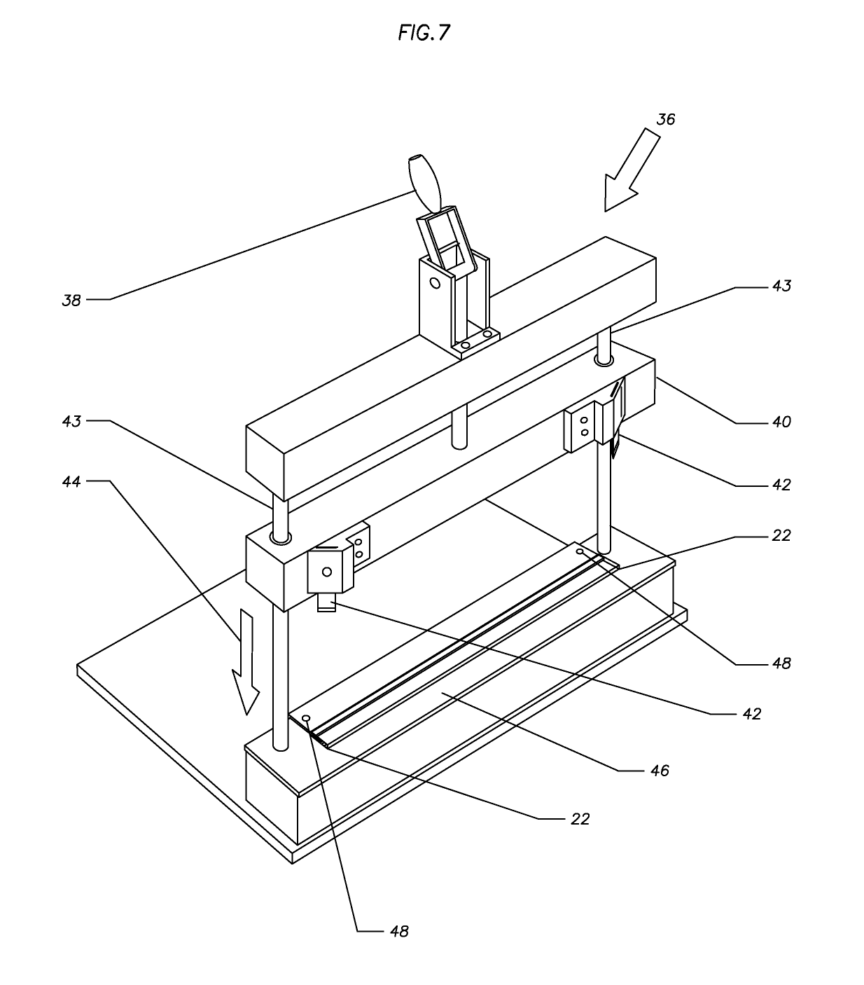

FIG. 7 is a perspective view that illustrates an apparatus (36) that is adapted to modify and trim the corners of the polymeric section or strip of a cleaning blade, such as cleaning blade (22), by pressing the handle (38) down in the direction of the arrow (44), thus forcing or making the cutting blades (42) come down along the slides or glides (43, 43) and to cut and trim the polymeric strip into the desired shape. Preferably, the cleaning blade affixed to the fixture (36) and aligned in a predetermined position with alignment pins (48, 48) in order to achieve a consistent cut every time. As will be apparent to one of skill in this field, the trimming apparatus and trimming process can be automated.

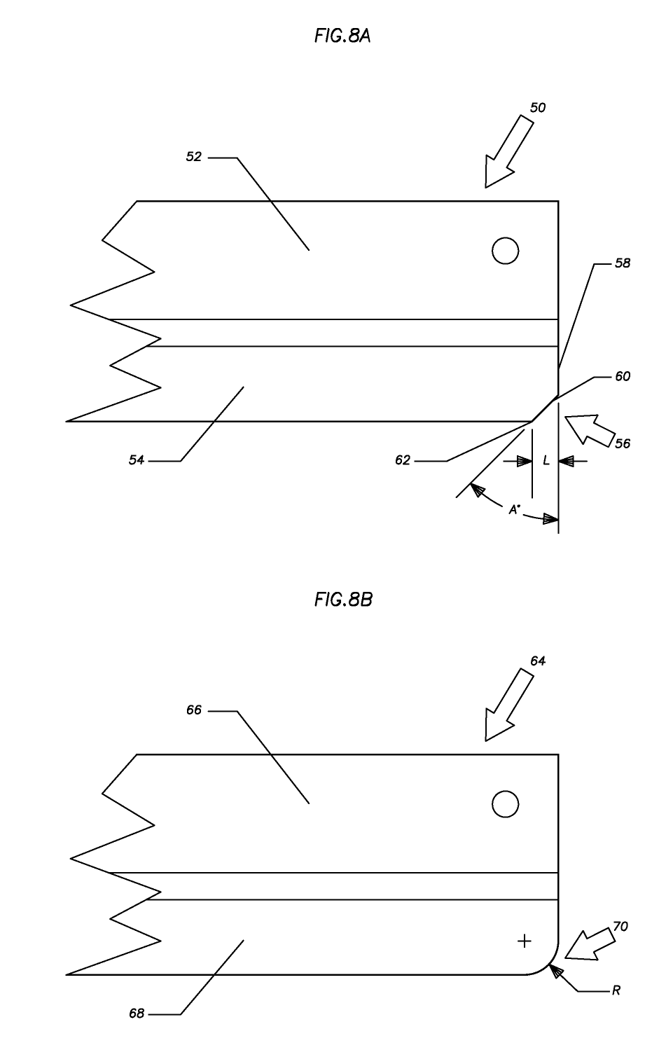

FIGS. 8A and 8B illustrate different, preferred corner shapes into which the distal edges or corners of the polymeric strip of a cleaning blade made be cut or trimmed and function to prevent or reduce the chances of the blade flipping during operation of the printer. FIG. 8A illustrates a preferred modified cleaning blade (50) that includes a metal bracket (52), a polymeric section or strip (54), and a modified chamfered or new molded corner shown at (56). While only one distal edge or corner (56) is shown, it is preferable that both corners of the strip be modified. The chamfered corner shape (56) is defined by an angle (A°) that extends between the distal, lateral edge of the polymeric section, shown at (58), and along the chamfer line (60) for a distance (L) between the edge (58) and to end point (62) that is at the leading edge of the polymeric section or strip (54) of the cleaning blade. While it is believed that any angle between 0 degrees and 90 degrees will permit the modified blade to work for its intended purpose. The angle (A°) preferably is in a range of about 10 to 80 degrees depending on the type of cartridge, components, media and/or toner used in the printing apparatus. The most preferred angle (A°) is about 45 degrees.

The maximum length of L is limited or dictated by the greatest width of the printed media permitted by any specific cartridge. Thus, the length L is chose so that the leading edge of the remaining strip has a width (as referred to above with reference to FIG. 3) that is at least as great as the intended printable width on a sheet of paper to be printed by the particular printer under consideration. In the event that a length L, for a given cartridge design, extends or penetrates into the printed area or printable area for a given cartridge, then a print defect in the form of toner haze on or along the margins of the page will appear.

FIG. 8B illustrates an alternate, preferred modified cleaning blade (64) having a metal bracket (66), a polymeric section or strip (68), and a distal edge or corner that has been modified with a cut, or a new cleaning blade (64) that has a new, molded round edge (70). The FIG. 8B blade is one example of an alternate class of modified blades, i.e., blades in which the corners are rounded or curved, rather than straight. Although only one preferred, alternate distal edge is illustrated in FIG. 8B, the preferred modified blade or new blade preferably has the rounded distal edges on both ends of the strip. The preferred round edge is defined by radius (R). The value of radius R depends on the clearance of the maximum size media printed with the specific cartridge model, the type of media printed, components used in the printing apparatus and the toner used. Thus, the value of R may vary. Also, complex curvatures, elliptical curvatures, offset centers for the radius and multiple chamfers or multiple, angled distal edges may also be used to modify previously used cleaning blades, or to manufacture new blades in order to reduce or eliminate the blade flipping problem. Preferably the rounded edges, or straight edges if used, do not extend into the printable area under the cleaning blade.

The trimmed corners preferably are straight edges along the Z axis, i.e., at right angles to the top and bottom surfaces of the strip. These vertical edges may also be at angles other than 90-degrees from the top and bottom surfaces of the polymeric strip.

The force (F) described in FIG. 3 that is applied on the cleaning blade by the photosensitive drum varies from one cartridge model to another. It is believed that in a prior art, 90 degree shaped corner, shown at (22) on FIG. 1, a force F is applied on the corner sufficiently high to create a high pressure point that increases the chances of the blade flipping, whereas in the modified cleaning blade edge, shown at (30) in FIGS. 2, and at 58 and 70 in FIGS. 8A and 8B, respectively, the force (F) is distributed such that the local force is significantly reduced at each point. Moreover, it is believed that the angled cut, shown at (30) in FIG. 2 reduces the force (F) normal to the blade because some of the force, inherently, is distributed parallel to the trim.

Although specific embodiments of the invention have been described, various modifications, alterations, alternative constructions, and equivalents are also encompassed within the scope of the invention.

The specification and drawings are, accordingly, to be regarded in an illustrative rather than a restrictive sense. It will, however, be evident that additions, subtractions, deletions and other modifications and changes may be made thereunto without departing from the broader spirit and scope of the invention as set forth in the claims.

1. A method for modifying a laser printer toner cartridge cleaning blade comprising:
providing a previously used laser printer toner cartridge cleaning blade formed of a metal bracket and polymeric strip;
the metal bracket adapted to be attached to said cartridge;
the cleaning blade adapted to extend along the axis of rotation of an image carrier drum of the cartridge;
said polymeric strip comprising a generally rectangular solid having a top surface, a bottom surface, a first side edge, a second side edge, a front edge having a predetermined width and a back edge;
said front edge adapted to contact said image carrier drum; and, shortening the predetermined width of the front edge by cutting and removing a portion of the strip from the front edge along the first side edge to form new first side edge that does not have a 90-degree angle between the front edge and said new first side edge; and,
cutting and removing a portion of the strip from the front edge along the second side edge to form new second side edge that does not have a 90-degree angle between the front edge and said new second side edge.

2. The method of claim 1 wherein said shortening includes removing a triangular portion of the strip that includes at least a part of the first side edge and removing a triangular portion of the strip that includes at least a part of the second side edge.

3. The method of claim 1 wherein said shortening includes cutting to form rounded corners.

4. The method of claim 1 wherein said shortening includes cutting and removing a portion of the strip from the front edge along the first side edge to form new first side edge having an angle less than 90-degrees between the front edge and said new first side edge; and,
cutting and removing a portion of the strip from the front edge along the second side edge to form new second side edge having an angle less than 90-degrees between the front edge and said new second side edge.

5-13. (canceled)

14. A method of remanufacturing a laser printer toner cartridge, the toner cartridge having a cleaning blade, the cleaning blade having a polymer strip having a leading edge configured to wipe toner residue off of a photosensitive member, the leading edge having a first predetermined width and distal ends, the method comprising:
removing the cleaning blade from the toner cartridge;
installing in the toner cartridge a modified previously used cleaning blade, the modified previously used cleaning blade having a leading edge with a second predetermined width and modified distal ends;
the second predetermined width less than the first predetermined width and the modified distal ends being chamfered or rounded.

15. The method of claim 14 wherein the modified distal ends are chamfered, and wherein the chamfer forms an angle with the leading edge of between 10 and 80 degrees.

16. The method of claim 15 wherein the chamfer forms an angle with the leading edge of 45 degrees.

17. A remanufactured laser printer toner cartridge, comprising:
a cartridge housing;
a waste bin;
a photosensitive member and a cleaning blade assembled in the waste bin;
the cleaning blade having a polymer strip having a leading edge configured to wipe toner residue off of the photosensitive member, the leading edge having distal ends;
the distal ends being chamfered or rounded.

18. The remanufactured laser printer toner cartridge of claim 17, wherein the cleaning blade further comprises a modified previously used cleaning blade, the distal ends of the leading edge having been modified from a substantially square configuration by cutting.

19. The remanufactured laser printer toner cartridge of claim 18, wherein the modified distal ends are chamfered, and wherein the chamfer forms an angle with the leading edge of between 10 and 80 degrees.

20. The remanufactured laser printer toner cartridge of claim 19, wherein the chamfer forms an angle with the leading edge of 45 degrees.
